(19) United States
(12) Patent Application Publication
(10) Pub. No.: US 2022/0092445 A1
(43) Pub. Date: Mar. 24, 2022

(54) Training Method and Computer System Using the Same

(71) Applicant: Libgirl Co., Ltd., Taipei City (TW)

(72) Inventors: Shih-Hao Hsu, New Taipei City (TW); Shih-Chia Chen, New Taipei City (TW)

(21) Appl. No.: 17/027,698

(22) Filed: Sep. 21, 2020

(51) Int. Cl. G06N 5/04; G06K 9/62; G06N 3/02

(52) U.S. Cl. CPC G06N 5/04; G06N 3/02; G06K 9/6262; G06K 9/6256

(57) ABSTRACT

A training method of a computing model-X, comprises obtaining an inference input signal of at least one inference input signal from a training dataset and a teacher signal; transmitting the inference input signal to the at least one inference input node and transmitting the teacher signal to at least one teacher input node; receiving an output signal from the at least one output node; and calculating the teacher signal according to the output signal; wherein the training dataset comprises at least one predetermined set of an inference input signal and a corresponding golden output signal; wherein the computing model-X calculates and updates parameters thereof according to the inference input signal, the teacher signal, and the output signal with the associative learning rule; wherein all of the at least one teacher input node is added when the computing model-X training starts.

### BACKGROUND OF THE INVENTION

### 1. Field of the Invention

The present invention relates to a training method and a computer system using the same, and more particularly, to a training method and a computer system capable of automatically generating training data with high training efficiency.

### 2. Description of the Prior Art

With the development of machine learning models, artificial intelligence may be applied to applications such as object detection, image recognition, voice recognition, medical diagnosis, and self-driving cars. Inference refers to inputting data into a machine learning model, after a series of internal calculations, and finally obtaining the inference result of the machine learning model. In order to obtain an appropriate machine learning model, the machine learning needs to be trained first to establish appropriate machine learning model parameters, so that the machine learning model can generate appropriate inference results based on input data and parameters to achieve the above application.

In addition, using machine learning models generated to classify objects can achieve a high degree of accuracy or precision. However, to apply a machine learning model to preform inference with the desired behaviors, one has to train it with supervised learning algorithms. However, there are problems of efficiency or feasibility in the training processes in some cases. For example, for neural network models, problems such as vanishing gradient or exploding gradient may occur when the backpropagation algorithm is applied on RNNs or large networks. On the other hand, there is no effective general algorithm to train some promising computational models such as reservoir computing (RC) models.

Therefore, it is necessary to improve the prior art.

### SUMMARY OF THE INVENTION

It is therefore a primary objective of the present application to provide a training method and computer system for machine learning models training, to improve over disadvantages of the prior art.

An embodiment of the present invention discloses a training method of a computing model-X, which can be trained with an associative learning rule, which is configured with at least one inference input node and at least one output node, the training method comprises obtaining an inference input signal of at least one inference input signal from a training dataset and a teacher signal; transmitting the inference input signal to the at least one inference input node and transmitting the teacher signal to at least one teacher input node; receiving an output signal from the at least one output node; and calculating the teacher signal according to the output signal; wherein the training dataset comprises at least one predetermined set of an inference input signal and a corresponding golden output signal; wherein the computing model-X calculates and updates parameters thereof according to the inference input signal, the teacher signal, and the output signal with the associative learning rule; wherein all of the at least one teacher input node is added when the computing model-X training starts.

An embodiment of the present invention further discloses a computer system, applied to train a computing model-X, which is configured with at least one inference input node and at least one output node, comprises a processing unit; and a storage unit, storing a program code, wherein the program code instructs the processing unit to execute the following steps: obtaining an inference input signal of at least one inference input signal from a training dataset and a teacher signal; transmitting the inference input signal to the at least one inference input node and transmitting the teacher signal to at least one teacher input node; receiving an output signal from the at least one output node; and calculating the teacher signal according to the output signal; wherein the training dataset comprises at least one set of inference input signal and corresponding golden output signal; wherein the computing model-X calculates and updates parameters thereof according to the inference input signal, the teacher signal, and the output signal with the associative learning rule; wherein all of the at least one teacher input node is added when the computing model-X training starts.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computing model-X in the prior art.

FIG. 2 is a schematic diagram of a training method for a computing model-X according to an embodiment of the present invention.

FIG. 3 is a schematic diagram of a training process according to an embodiment of the present invention.

FIG. 4 is a schematic diagram of a computer system according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection or through an indirect electrical connection via other devices and connections.

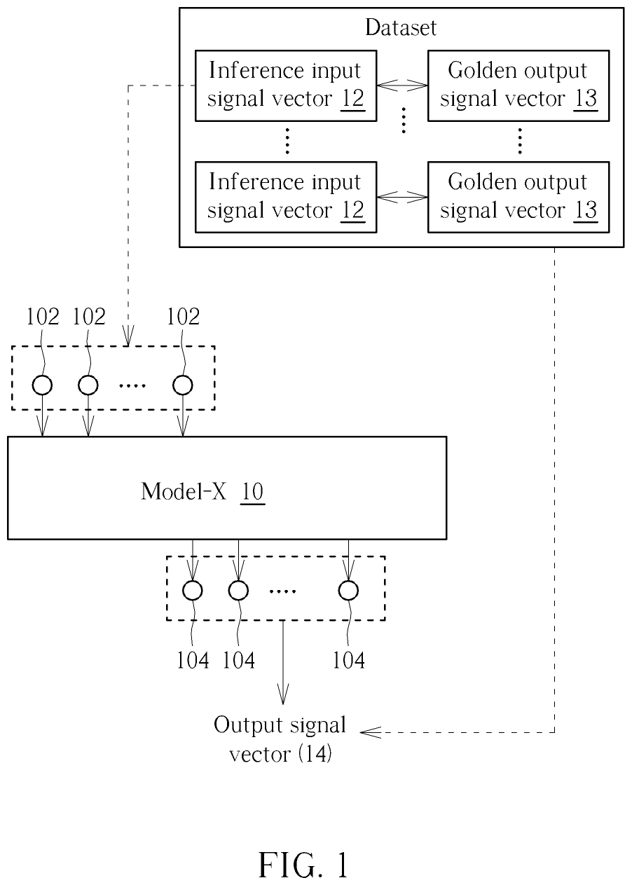

FIG. 1 is a schematic diagram of a computing model-X 10 in the prior art. In FIG. 1, a training dataset comprises a plurality of predetermined sets of an inference input signal vector 12 and a corresponding golden output signal vector 13. The computing model-X 10 is configured to learn a relationship between the inference input signal vector 12 and the corresponding golden output signal vector 13 by receiving the inference input signal vector 12 via inference input nodes 102 and outputting an output signal vector 14 via output nodes 104, to generate an inference function that may be applied to map new inference input vector 12 in practical application. Depending on the characteristics of the task, relationships between pairs of input signal vector 12 and output signal vector 13 may vary, e.g. mutually independent or chronologically related.

Moreover, since a relationship exists between the inference input signal vector 12 and the golden output signal vector 13, each set of the inference input signal vector 12 and the golden output signal vector 13 in the training dataset is predetermined. Thus, the computing model-X 10 may be trained to infer parameters thereof; that is, the computing model-X 10 may learn the relationship between the inference input signal vector 12 and the corresponding golden output signal vector 13. The training method of the prior art is transmitting the inference input signal vector 12 to the inference input nodes 102 and receiving the output signal vector 14 from the output nodes 104, and tracking the relationship between the inference input signal vector 12 and the corresponding golden output signal vector 13 to fine-tune the parameters thereof, so as to generate the output signal vector 14 to fit the golden output signal vector 13 as much as possible. Notably, not all elements of the inference input signal vector 12 come from the training dataset. For example, some elements of the inference input signal vector 12 may be determined according to the environment, such as the operation timestamp or the system temperature.

For example, if the number of the inference input nodes 102 is 3 (i.e., the number of elements of the inference input signal vector 12 is 3), and the inference input signal vector 12 is [0,2,1], the computing model-X 10 may calculate and update the parameters thereof according to an priority of the first, third and second element of the output signal vector 14 to fit the golden output signal vector 13 as much as possible.

Note that, the number of elements of the inference input signal vector 12 is the same as the number of the inference input nodes 102, and the relationship the model-X 10 learned is based on the relationships of the sets of the inference input signal vector 12 and the corresponding golden output signal vector 13, which are predetermined. In such a situation, when the external environment changes or the types of objects to be classified changes, the computing model-X 10 needs to be retrained, which takes costs and time to calculate and update the parameters thereof. Therefore, the present invention may train the computing model-X 10 efficiently with excellent efficiency to reduce the time to initialize parameter of multi loop present invention. In other words, the prevent may save the retraining time as the training time.

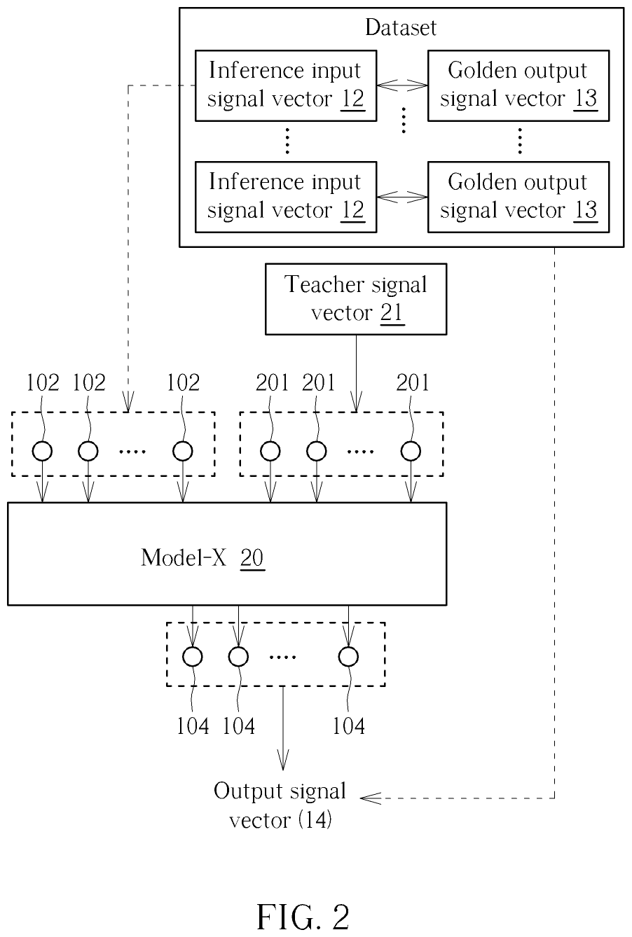

To improve the training efficiency, the present invention provides a training method and a computer system using the same, which are capable of automatically generating training data with high training efficiency to train models such as reservoir computing compared to the prior art. Please refer to FIG. 2, which is a schematic diagram of a computing model-X 20 according to an embodiment of the present invention. Compared with the prior art, teacher input nodes 201 are included in the computing model-X 20. In addition, at least one teacher signal vector 21 is transmitted to the computing model-X 20 via the teacher input nodes 201 during the training procedure. Besides, the functions of the remaining components in the computing model-X 20 are the same as those in the computing model-X 10 shown in FIG. 1, which are not narrated herein for brevity.

More specifically, the teacher signal vector 21 and the inference input nodes 102 may be regarded as a whole input to the computing model-X 20. Any computing model-X configured to infer parameters thereof following with an associative learning rule may be trained with the method of the present invention to improve the training efficiency. However, unlike the inference input signal vector 12 being predetermined in the training dataset, the teacher signal vector 21 may vary during the training procedure even if the set of the inference input signal vector 12 and the golden output signal vector 13 is the same. For example, when the first element of the output signal vector 14 is twice as expected, the teacher signal vector 21 corresponding to the first element of the output signal vector 14 may vary for the same set of the inference input signal vector 12 and the golden output signal vector 13. In other words, the teacher signal vector 21 may be calculated according to the output signal vector 14.

An associative learning rule is a learning rule that let a model tend to produce behaviors that are similar or identical to its behavior before learning when seeing new inputs which has similarity to the inputs in the learning processes. To be specific, if in the learning processes, a model X receives an input A and produces an output P, where A is a mathematical composition of signal C1, C2, C3 . . . , and after applying a learning rule L, model X become more likely to produce output P when seeing an input B which is a mathematical composition of some other signals and a subset of the constituent signals of A, e.g. only C1 and C2, then learning rule L is an associative learning rule. Here the mathematical composition is arbitrary, e.g. concatenating vectors C1 of m dimension and C2 of n dimension to a vector A of m+n dimension, simple superposition of vectors C1 and C2 of identical dimension, or concatenating sequence C2 after sequence C1. Also, sharing common subset of constituent signals is only one approach to describe the concepts of similarity, and any other effective definitions or descriptions of similarity may apply.

In the following description, when the model-X 20 receives the predetermined inference input signal vector 12 via the plurality of inference input nodes 102 and further receives the variable teacher signal vector 21 via the plurality of teacher input nodes 201 to output the output signal vector 14 from the plurality of output nodes 14 according to the parameters thereof, the inference input signal vector 12, the teacher signal vector 21, the output signal vector 14, the golden output signal vector 13, or their combination, the model-X 20 performs a teacher-following behavior model.

In the model-X 20, the teacher signal vector 21 may be adjusted to help learning the relationship between the inference input signal vector 12 and the corresponding golden output signal vector 13. More specifically, the teacher signal vector 21 may be adjusted to control the model-X 20 to let the output signal vector 14 as close as the corresponding golden output signal vector 13. The model-X 20, therefore, may learn (according to the associative learning) to infer the corresponding output signal vector 14 as closely as possible to the golden output signal vector 13 for the certain inference input signal vector 12. For example, if an element of the output signal vector 14 is larger than an element of the golden signal vector 13 in the same/corresponding fields, then the teacher signal may be adjusted again and again for the same inference input signal vector 12 from the training dataset.

More specifically, the teacher-following behavior is defined by that the output signal vector 14 of the model-X 20 is corresponding to the teacher signal vector 21, which satisfies the following conditions:
1) The output signal vector 14 is partially or fully controlled by the teacher signal vector 21. The teacher signal vector 21 is corresponding to the certain inference input vector 12.
2) There is a kind of instruction-free teacher signal vector 21 such that the teacher signal vector 21 does not control the output signal vector 14.

The design of the teacher-following behavior has to satisfy the criteria that one can control the outputs of the model-X 20 by the teacher signal vector 21 to fulfill the assigned tasks. By such design, one may also build the computing model-X 20 with such teacher-following behavior by the training methodologies in the prior art. For example, the computing model-X 20 may be formed by an artificial neural network with backpropagation, a spiking neural network with Hebbian learning and ReSuMe, or a classic reservoir computing approaches. After obtaining a model that performs teacher-following behavior, by generating teacher signals to control the behavior of the model to fit the golden output and applying associative learning rules, one can train the model for various tasks, i.e. various datasets.

Moreover, once the inference input signal vector 12 is obtained from the training dataset, the teacher signal vector 21 is correspondingly calculated by the embodiment of the present invention. The method to obtain the teacher signal vector 21 may be calculating according to the output signal vector 14. In addition, the teacher signal vector 21 may be further calculated according to the inference input signal vector 12, the golden output signal vector 13, the output signal vector 14, or a combination thereof.

In an embodiment, the teacher signal vector 21 may be the same as the golden output signal vector 13, such that the computing model-X 20 may infer the relationship between the inference input signal vector 12 and the output signal vector 14. More specifically, the function of the teacher signal vector 21 is to adjust the appropriate output signal vector 14, to train the computing model-X 20 such that the computing model-X 20 may infer the relationship between the inference input signal vector 12 and the output signal vector 14 according to the associative learning rule. In another embodiment, the teacher signal vector 21 may be the difference between the inference input signal vector 12 and the golden output signal vector 13, such that the computing model-X 20 may infer a quantity of the output signal vector 13 to be adjusted. In another embodiment, the teacher signal vector 21 may be obtained by retrieving pre-calibration values from a look-up table according to the inference input signal vector 12, the golden output signal vector 13, the output signal vector 14, or a combination thereof.

In addition, the teacher signal vector 21 may be calculated according to an error, which is obtained according to the golden output signal vector 13 and the output signal vector 14. More specifically, an embodiment of the present invention compares the output signal vector 14 with the golden output signal vector 13 and then uses the difference to calculate a new teacher signal vector 21. The new teacher signal vector 21 may allow the computing model-X 20 to reach or maintain the golden output signal vector 13. The embodiment may further adjust the teacher signal vector 21 according to the historical data and the occurrence rate of the difference, so as to enhance accuracy and stability of the computing model-X 20.

For example, the error may be a difference between the golden output signal vector 13 and the output signal vector 14, an integral of the difference during a past period, a derivative of the difference during the past period, or a linear combination thereof. An integral term increases action in relation not only to the error but also to the time for which it has persisted. So, if the applied teacher signal vector 21 is not enough to bring the error to zero, this teacher signal vector 21 will be increased as time passes. A derivative term does not consider the error (meaning it cannot bring the error to zero), but the rate of change of error, trying to bring this rate to zero, which aims at flattening the error trajectory into a horizontal line.

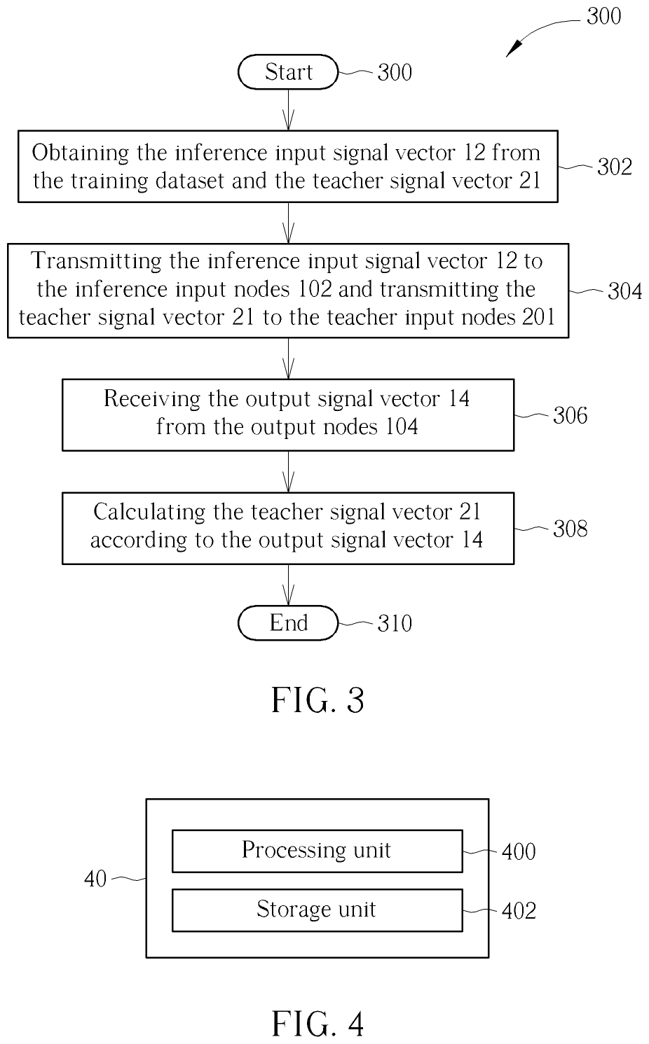

The above operations can be summarized into a training process 30, as shown in FIG. 3. The training process 30 comprises the following steps:

Step 300: Start.

Step 302: Obtaining the inference input signal vector 12 from the training dataset and obtaining the teacher signal vector 21.

Step 304: Transmitting the inference input signal vector 12 to the inference input nodes 102 and transmitting the teacher signal vector 21 to the teacher input nodes 201.

Step 306: Receiving the output signal vector 14 from the output nodes 104.

Step 308: Calculating the teacher signal vector 21 according to the output signal vector 14.

Step 310: End.

As mentioned above, in the training process 30, the computing model-X 20 may infer the relationship between the inference input signal vector 12 and the output signal vector 14 according to the associative learning rule. Moreover, In Step 308, the teacher signal vector 21 may be generated by the parameters of the inference input signal vector 12, the golden output signal vector 13, the output signal vector 14, the conditions of the surrounding where the computing model-X 20 located, or a combination thereof. Those skilled in the art may make modifications and alterations accordingly, and not limited herein. For example, when the computing model-X 20 is working in the 25 degrees Celsius environment, the teacher signal vector 21 is the same as the difference between the golden output signal vector 13 and the output signal vector 14. And, when the computing model-X 20 is at 75 degrees Celsius, the teacher signal vector 21 may be set to 1.5 times the difference to enforce the teaching strength because of signal noise ratio. In other words, Step 308 determines the teacher signal vector 21 according to the golden signal vector 13, which are determined according to the inference input signal vector 12, and the output signal vector 14.

The detailed operations of the training process 30 may be referred to the foregoing description, which are not narrated herein for brevity.

Notably, the training process 30 may be executed more than one time. For example, if the number of the training data sets in the training dataset is 100, then the training process 30 will undergo 100 times. As can be seen, the parameters of the computing model-X 20 may vary after the training procedure; that is, the output of the computing model-X 20 may vary even if the sets of the inference input signal vectors and the golden output signal vector is the same. Therefore, there may be some iteration over all inference input signal vectors from the dataset. In an embodiment, the number of the iteration is set to be 3; thus, each inference input signal vector 12 from the training dataset will be transmitted to the inference input nodes 102 for three times, and the golden output signal vector 13 is fixed at the predetermined value while the accompanying teacher signal vector 21 may vary in each time.

In an embodiment, after the inference input signal vector 12 is transmitted, the inference input signal vector 12 is kept at the inference input nodes to obtain the fittest teacher signal vector 21 (that is, another inference input signal vector with the same value is inputted to the computing model-X 20.) More specifically, an embodiment of the present invention transmits a first teacher signal to the teacher input nodes 201, receives a first output signal from the output nodes 104, and calculates the first teacher signal according to the first output signal. Moreover, the embodiment may transmit a second teacher signal to the teacher input nodes 201, receives a second output signal from the output nodes 104, and calculates the second teacher signal according to the second output signal.

For example, for learning in different stages (such as coarse adjustment and refine adjustment of a robot's controlling), if the inference input signal vector 12 is kept to [1,0,0], and the first teacher signal is [0,0,0,0] in the first epoch, wherein the first entry “0” means that the first teacher signal is instruction-free. However, when the output is too far from the golden output signal vector 13, an embodiment of the present invention may set the first teacher signal to be [1,1,0,0] and set the second teacher signal to be [1,1,1,0] in the second epoch. Besides, the embodiment of the present invention may store and compare the training results and combine the training results to calculate the fitness teacher signal. For example, in the above example, with these two strokes of information, an embodiment of the present invention may automatically calibrate itself. Another embodiment of the present invention may also measure the sensitivity of the teacher signal vector 21; for example, the embodiment may obtain the gradients of the output signal vector 14 caused by the teacher signal vector 21. In addition, the other embodiments may second-orderly fine-tune the computing model-X 20 in a fast response. In other words, the computing model-X 20 may be trained with accuracy and stability.

In addition, the first/second teacher signal in different epochs may be instruction-free if the error is less than a threshold (as shown in the second epoch of the teacher-following behavior), and the first/second teacher signal may be proportional to the error otherwise. However, an embodiment of the present invention may apply different methods, respectively, to the first teacher signal and the second teacher signal. For example, the first teacher signal is calculated proportionally to the error, while the second teacher signal is calculated according to an integration of the error during a measurement period.

In an embodiment, all of the plurality of teacher input nodes are removed when the computing model-X 20 completes training, so as apply to the realistic scenario. Those skilled in the art may make modifications and alterations accordingly, which are not limited herein. For example, in an embodiment, two teacher input nodes are kept as Universal Asynchronous Receiver/Transmitter (UART) while others are removed when the computing model-X 20 completes training with the capability of upgrading the computing model-X 20 by over-the-air programming (OTA). In another embodiment, the training data in the training dataset may be predetermined, calibrated in advance, or automatically generated according to the practical scenario, such as input by users, temperature measuring, etc.

Notably, the training process 30 may be implemented and/or executed by a computer system. For example, FIG. 4 is a schematic diagram of a computer system 40 according to an embodiment of the present invention. As shown in FIG. 4, the computer system 40 comprises a processing unit 400 and a storage unit 402. In an embodiment, each unit of the system 40 may be implemented by an application-specific integrated circuit (ASIC). In an embodiment, the processing unit 400 may be an application processor (AP) or a digital signal processor (DSP), wherein the processing unit 400 may be a central processing unit (CPU), a graphics processing unit (GPU) or a tensor processing unit (TPU) to implement the training for the computing model-X 20 mentioned above, and not limited thereto. The storage unit 402 may store a training dataset and a program code to instruct the processing unit 400 to perform the function of the training process 30 of the present invention. The storage unit 402 may be a ROM (Read-only Memory), a RAM (Random-access Memory), a CD-ROM, an Optical Data Storage Device), a Non-volatile Memory such as an electrically erasable programmable read-only memory (EEPROM) or a flash memory, and not limited thereto.

Notably, the embodiments stated in the above are utilized for illustrating the concept of the present application. Those skilled in the art may make modifications and alterations accordingly and not limited herein to fit the practical scenario. For example, the number of the teacher nodes may not be limited to the number of the output nodes; that is, the number of the teacher nodes may be larger or less than the number of the output nodes. In an embodiment, the number of the inference input nodes 102, the number of the output nodes 104, or the number of the teacher input nodes may be 1; that is, the inference input signal vector 12, the output signal vector 14, or the teacher signal vector 21 may be a scalar. Therefore, as long as a training method capable of automatically generating training data to improve the training efficiency to train machine learning models, e.g. reservoir computing, in a supervised manner, which satisfying the teacher-following behavior, the requirements of the present application are satisfied and within the scope of the present application.

In summary, the present invention provides a training method and a computer system using the same, which are capable of automatically generating training data with high training efficiency. With the teacher signal inputted via at least one added teacher node, the computing model-X may calculate and update the parameters thereof, which improves the training efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A training method of a computing model-X, which is configured with at least one inference input node and at least one output node, the training method comprising:
obtaining an inference input signal of at least one inference input signal from a training dataset and a teacher signal;
transmitting the inference input signal to the at least one inference input node and transmitting the teacher signal to at least one teacher input node;
receiving an output signal from the at least one output node; and
calculating the teacher signal according to the output signal;
wherein when the computing model-X finishes training with an associative learning rule, the computing model-X is configured to infer things;
wherein the training dataset comprises at least one predetermined set of an inference input signal and a corresponding golden output signal;
wherein the computing model-X calculates and updates parameters thereof according to the inference input signal, the teacher signal, and the output signal with the associative learning rule;
wherein all of the at least one teacher input node is added when the computing model-X training starts.

2. The training method of claim 1, wherein calculating the teacher signal according to the output signal further comprises:
calculating the teacher signal according to the at least one inference input signal, at least one golden output signal corresponding to the at least one inference input signal, at least one output signal, or a combination thereof.

3. The training method of claim 2, wherein calculating the teacher signal according to the at least one inference input signal, the at least one golden output signal corresponding to the at least one inference input signal, the at least one output signal, or the combination thereof comprises:
obtaining an error according to the at least one golden output signal and the at least one output signal; and
calculating the teacher signal according to the error corresponding to the at least one inference input signal.

4. The training method of claim 3, wherein the error is a difference between a golden output signal of the at least one golden output signal and the output signal, an integral of the difference during a past period, a derivative of the difference during the past period, or a linear combination thereof.

5. The training method of claim 1, wherein transmitting the inference input signal to the at least one inference input node and transmitting the teacher signal to the at least one teacher input node; receiving the output signal from the at least one output node; and calculating the teacher signal according to the output signal comprise:
transmitting a first teacher signal to the at least one teacher input node;
receiving a first output signal from the at least one output node;
calculating the first teacher signal according to the first output signal;
transmitting a second teacher signal to the at least one teacher input node;
receiving a second output signal from the at least one output node; and
calculating the second teacher signal according to the second output signal.

6. The training method of claim 5, wherein calculating the first/second teacher signal according to the first/second output signal further comprises:
calculating the first/second teacher signal according to the inference input signal, a golden output signal corresponding to the inference input signal, the first/second output signal, or a combination thereof.

7. The training method of claim 6, wherein calculating the first/second teacher signal according to the inference input signal, the golden output signal corresponding to the inference input signal, the first/second output signal, or the combination thereof comprises:
obtaining a first/second error according to the golden output signal and the first/second output signal; and
calculating the first/second teacher signal according to the first/second error corresponding to the inference input signal.

8. The training method of claim 7, wherein the first/second error is a first/second difference between the golden output signal and the first/second output signal, a first/second integral of the first/second difference between the golden output signal and the first/second output signal during a past period, a first/second derivative of the first/second difference during the past period, a linear combination thereof.

9. The training method of claim 1, wherein the computing model-X is an artificial neural network, a spiking neural network, or a Reservoir computing model-X.

10. The training method of claim 1, wherein all of at least one teacher input node is removed when the model-X training completes.

11. A computer system, applied to train a computing model-X, which is configured with at least one inference input node and at least one output node, comprising:
a processing unit; and
a storage unit, storing a program code, wherein the program code instructs the processing unit to execute the following steps:
obtaining an inference input signal of at least one inference input signal from a training dataset and a teacher signal;
transmitting the inference input signal to the at least one inference input node and transmitting the teacher signal to at least one teacher input node;
receiving an output signal from the at least one output node; and
calculating the teacher signal according to the output signal;
wherein the training dataset comprises at least one predetermined set of inference input signal and corresponding golden output signal;
wherein when the computing model-X finishes training with an associative learning rule, the computing model-X is configured to infer things;
wherein the computing model-X calculates and updates parameters thereof according to the inference input signal, the teacher signal, and the output signal with the associative learning rule;
wherein all of the at least one teacher input node is added when the computing model-X training starts.

12. The training method of claim 11, wherein calculating the teacher signal according to the output signal further comprises:
calculating the teacher signal according to the at least one inference input signal, at least one golden output signal corresponding to the at least one inference input signal, at least one output signal, or a combination thereof.

13. The training method of claim 12, wherein calculating the teacher signal according to the at least one inference input signal, the at least one golden output signal corresponding to the at least one inference input signal, the at least one output signal, or the combination thereof comprises:
obtaining an error according to the at least one golden output signal and the at least one output signal; and
calculating the teacher signal according to the error corresponding to the at least one inference input signal.

14. The training method of claim 13, wherein the error is a difference between a golden output signal of the at least one golden output signal and the output signal, an integral of the difference during a past period, a derivative of the difference during the past period, or a linear combination thereof.

15. The training method of claim 11, wherein transmitting the inference input signal to the at least one inference input node and transmitting the teacher signal to the at least one teacher input node; receiving the output signal from the at least one output node; and calculating the teacher signal according to the output signal comprise:
transmitting a first teacher signal to the at least one teacher input node;
receiving a first output signal from the at least one output node;
calculating the first teacher signal according to the first output signal;
transmitting a second teacher signal to the at least one teacher input node;
receiving a second output signal from the at least one output node; and
calculating the second teacher signal according to the second output signal.

16. The training method of claim 15, wherein calculating the first/second teacher signal according to the first/second output signal further comprises:
calculating the first/second teacher signal according to the inference input signal, a golden output signal corresponding to the inference input signal, the first/second output signal, or a combination thereof.

17. The training method of claim 16, wherein calculating the first/second teacher signal according to the inference input signal, the golden output signal corresponding to the inference input signal, the first/second output signal, or the combination thereof comprises:
obtaining a first/second error according to the golden output signal and the first/second output signal; and
calculating the first/second teacher signal according to the first/second error corresponding to the inference input signal.

18. The training method of claim 17, wherein the first/second error is a first/second difference between the golden output signal and the first/second output signal, a first/second integral of the first/second difference between the golden output signal and the first/second output signal during a past period, a first/second derivative of the first/second difference during the past period, a linear combination thereof.

19. The training method of claim 11, wherein the computing model-X is an artificial neural network, a spiking neural network, or a Reservoir computing model-X.

20. The training method of claim 11, wherein all of at least one teacher input node is removed when the model-X training completes.
